(19) United States
(12) Patent Application Publication
(10) Pub. No.: US 2021/0341724 A1
(43) Pub. Date: Nov. 4, 2021

(54) METHOD FOR CORRECTING AN IMAGING ERROR IN A MICROSCOPE SYSTEM, AND MICROSCOPE SYSTEM

(71) Applicant: LEICA MICROSYSTEMS CMS GMBH, Wetzlar (DE)

(72) Inventor: Christian SCHUMANN, Lich (DE)

(21) Appl. No.: 17/283,259

(22) PCT Filed: Oct. 18, 2019
(86) PCT No.: PCT/EP2019/078385

§ 371 Date: Apr. 7, 2021

(30) Foreign Application Priority Data
Oct. 19, 2018 (DE) 10 2018 126 021.0

(51) Int. Cl. G02B 21/36; G02B 21/06; G02B 21/02

(52) U.S. Cl. CPC G02B 21/365; G02B 21/02; G02B 21/06

(57) ABSTRACT

A method for correcting an imaging error in a microscope system, which has a microscope and an optical component, includes receiving at least one setting variable from a remote storage module via a data remote transmission network. The at least one setting variable is assigned to the imaging error and individual to the optical component. A correction element contained in the optical component is adjusted to correct the imaging error using the at least one setting variable.

### CROSS-REFERENCE TO PRIOR APPLICATIONS

This application is a U.S. National Phase Application under 35 U.S.C. § 371 of International Application No. PCT/EP2019/078385, filed on Oct. 18, 2019, and claims benefit to German Patent Application No. DE 10 2018 126 021.0, filed on Oct. 19, 2018. The International Application was published in German on Apr. 23, 2020 as WO 2020/079230 under PCT Article 21(2).

### FIELD

The invention relates to a method for correcting an imaging error in a microscope system which comprises a microscope and an optical component, wherein a correction element arranged in the optical component is adjusted to correct the imaging error. The invention furthermore relates to a microscope system which comprises a microscope and an optical component having a correction element.

### BACKGROUND

To increase the quality of a light-microscopy image of a sample, it is frequently necessary in practice to perform a corrective adjustment on the optical imaging system in microscope operation, for example to correct a spherical imaging error if there is an index of refraction maladjustment. This adjustment requires the knowledge of specific control data of individual components of the optical imaging system. In particular in the case of exchangeable components such as exchangeable objectives attachable to a microscope, it represents a challenge to provide these control data, which are individual due to tolerance-related manufacturing variations even for exchangeable objectives of the same model, while maintaining already existing connection interfaces between microscope and exchangeable objective.

Optical components such as objectives for photographic cameras are known from the prior art, which have storage components in which specific control data are stored. However, equipping optical components with storage components is linked to a comparatively high expenditure. Furthermore, such optical components are not compatible with existing optical systems, since they require a separate connection interface.

### SUMMARY

In an embodiment, the present invention provides a method for correcting an imaging error in a microscope system, which comprises a microscope and an optical component. The method includes receiving at least one setting variable from a remote storage module via a data remote transmission network. The at least one setting variable is assigned to the imaging error and individual to the optical component. A correction element contained in the optical component is adjusted to correct the imaging error using the at least one setting variable.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 shows a schematic illustration of a microscope system as an exemplary embodiment; and

FIG. 2 shows a flow chart which shows an embodiment of a method for correcting an imaging error by means of the microscope system according to FIG. 1.

### DETAILED DESCRIPTION

Embodiments of the present invention provide a method and also a microscope system having a microscope and an optical component which permit simple and reliable correction of imaging errors.

In an embodiment, the invention provides a method for correcting an imaging error in a microscope system, which comprises a microscope and an optical component, wherein a correction element(s) (or correction means) contained in the optical component is adjusted to correct the imaging error. In the method according to an embodiment of the invention, at least one setting variable, which is associated with the imaging error and is individual for the optical component, and on the basis of which the correction element is adjustable, is received from a remote storage module via a data remote transmission network.

In an embodiment, the above-mentioned optical component is in particular an objective, without being restricted thereto. Moreover, the optical component preferably forms an exchangeable component, i.e., a component which is provided as such separately from the microscope and is only attached as needed to the microscope. However, it is also conceivable that the optical component according to an embodiment of the invention is an integral component of the microscope itself.

The remote storage module forms a functional unit spatially separated from the microscope and the optical component. This functional unit can be, for example, part of a server or a server system comprising multiple servers. It is also conceivable to implement the remote storage module in the form of a decentralized storage unit referred to as a cloud.

In particular the Internet or a local network can be used as the data remote transmission network according to an embodiment of the invention, which is used to transmit the setting variable associated with the imaging error to be corrected.

The setting variable individual for the optical component is stored in the remote storage module, for example in the form of a table, in which various values of the setting variable are each associated with one or more values of the imaging error to be corrected. The setting variable individual for the optical component can also be saved in the form of an assignment rule, which respectively assigns the values of the imaging error to be corrected a value of the setting variable. The correction behavior of the individual optical component is characterized in consideration of the manufacturing tolerances by the individual assignment between imaging error and setting variable. This permits an imaging error occurring in the microscope system to be corrected individually by component and thus precisely in a simple manner.

The individual setting variable is received via a data remote transmission network, i.e., an interface which is typically provided in any case in the microscope system. In contrast to a solution in which a storage unit which is integrated into the optical component itself is used instead of the remote storage module, the method according to an embodiment of the invention thus does not require a separate interface for data transmission between microscope and optical component. The method according to an embodiment of the invention may be implemented particularly simply in this way.

In one preferred embodiment, the at least one setting variable is individually measured on the optical component or is calculated from optical data of the optical component and then stored in the remote storage module. For example, the setting variable can be individually ascertained in a final assembly step for the optical component with application of an interferometric method.

In one particularly preferred embodiment, a unique identifier is assigned to the optical component, by means of which the at least one setting variable is uniquely assignable to the optical component. A linkage between the unique identifier assigned to the optical component and the individually determined setting variable is preferably stored in the remote storage module. The unique identifier is, for example, an item of human-readable information, for example in the form of a serial number, or machine-readable information, for example in the form of a barcode, a QR code, or an RFID tag, which are each readable on the optical component.

In a further preferred embodiment, an authentication step is carried out via the data remote transmission network before the at least one setting variable is received. An authentication can be carried out in particular by an operator, for example by inputting a user identification and/or a password.

In one particularly preferred embodiment, the imaging error to be corrected is determined at least using the microscope. The imaging error to be corrected is preferably transmitted in the form of development coefficients of orthogonal polynomials, in particular Zernike polynomials. This is a particularly simple way to quantify the imaging error to be corrected. Alternatively or additionally, the parameters causing or influencing the imaging error to be corrected, for example a cover slip thickness, an index of refraction of the sample or of the immersion medium, are determined using the microscope.

In a further preferred embodiment, the imaging error is transmitted from the microscope to the remote storage module. At least one setting variable, which is associated with the transmitted imaging error and is individual for the optical component, and on the basis of which the correction element is settable, is received from the remote storage module via a data remote transmission network. The adjustment of the correction element is carried out on the basis of the setting variable assigned to the transmitted imaging error. This permits a correction of the imaging error determined by the microscope by means of the control data, which are individual for the optical component.

An index of refraction of a sample, an embedding medium, an immersion medium, and/or a cover slip and/or the thickness of the cover slip and/or the position of the object plane relative to the position of the cover slip are preferably determined to determine the imaging error to be corrected. These data can also be transmitted to the remote storage module. In this way, an individual ascertainment of the setting variable can be carried out not only at the location of the microscope but also in a decentralized manner and the setting variable can then be transmitted to the microscope.

In another embodiment, the invention provides a microscope system, comprising a microscope and an optical component having a correction element, which is adjustable to correct an imaging error. The microscope furthermore comprises a remote storage module, wherein the microscope system is designed to receive at least one setting variable, which is assigned to the imaging error and is individual for the optical component, and on the basis of which the correction element is adjustable, via a data remote transmission network from the remote storage module.

In one preferred refinement, the remote storage module is designed to calculate the individual setting variable on the basis of data received from the microscope and to transmit it to the microscope.

In a further preferred refinement, the microscope comprises a control unit, which is designed to activate the correction element contained in the optical component to correct the imaging error. The correction element is adjusted to correct the imaging error on the basis of the assignment, which is individual for the optical component, between the imaging error and the setting variable assigned to the imaging error. Solely as an example, if one considers a case in which the imaging error is determined as a function of the cover slip thickness, the setting variable can thus be queried each time, i.e., for each specifically determined cover slip thickness, from a table stored in the remote storage module or can be ascertained from an assignment rule stored in the remote storage module. Alternatively, the table or the assignment rule can be received and stored once, i.e., for all relevant cover slip thicknesses, by the control unit and then evaluated.

Alternatively or additionally, items of information about the optical effect of the setting variable can also be received, on the basis of which a target value of the setting variable, which is assigned in each case to different cover slip thicknesses, can be calculated in each case, for example, by the control unit. The setting variable can also first be generated in the remote storage module at the query time on the basis of provided items of information, for example a correction effect of the setting variable and/or items of information received from the microscope, for example a cover slip thickness.

In one preferred refinement, the microscope system is designed to read out a unique identifier assigned to the optical component, by means of which the at least one setting variable is uniquely assignable to the optical component.

The microscope system preferably comprises an input device for the user-side input of the unique identifier assigned to the optical component. The input device can be, for example, a keyboard or a numeric keypad.

It is advantageous if an item of hysteresis information individual for the optical component is stored in the remote storage module, in consideration of which the correction element is adjustable. A mechanical hysteresis of the correction element is an error source in the adjustment of the correction element. The hysteresis information stored on the remote storage module enables the control unit to carry out a component-individual adjustment of the correction element in consideration of the stored hysteresis. For example, the hysteresis information can comprise an offset which has to be added to the setting variable assigned to the received imaging error or subtracted therefrom in order to compensate for the hysteresis. Alternatively, the hysteresis information can comprise instructions according to which the correction element is only to be adjusted in a specific way. For example, if the correction element is a lens, the hysteresis information can thus in particular comprise the instruction to approach the position of the lens assigned to the setting variable from only one direction.

The correction element preferably comprises at least one lens, which is movable along the optical axis of the optical component to correct the imaging error. Spherical imaging errors may be reliably corrected in a simple manner by a lens or lens group movable along the optical axis.

The optical component preferably comprises a mechanical stop and/or a light barrier for registering a reference value of the setting variable. The instantaneous value of the setting variable relative to the mechanical stop and/or the light barrier is registered by element of the reference value by a suitable measuring system, preferably an encoder. A deviation between an actual value and a target value of the setting variable can be registered in this way, for example.

In a further embodiment, additional optical data, which are individually related to the optical component, are stored in the remote storage module. These optical data can be used to determine the imaging error to be corrected with the aid of the microscope. The optical data are stored in the remote storage module and can be received by the microscope via the data remote transmission network. The optical data can be in particular the numerical aperture, the index of refraction of an immersion medium, the enlargement, and/or the color correction of the optical component. Furthermore, further data required for the operation of the microscope system, such as operating distance, location of the exit pupil, vignetting data, control data for autofocus or focus holding systems, and/or laser destruction thresholds and also name, order number, and/or serial number can also be stored in the remote storage module. In particular, one or more checksums, so-called hashes, can be stored in the remote storage module, which are used to check the received setting variable.

Further features and advantages of embodiments of the invention result from the following description, which explains in greater detail exemplary embodiments of the invention in conjunction with the appended figures.

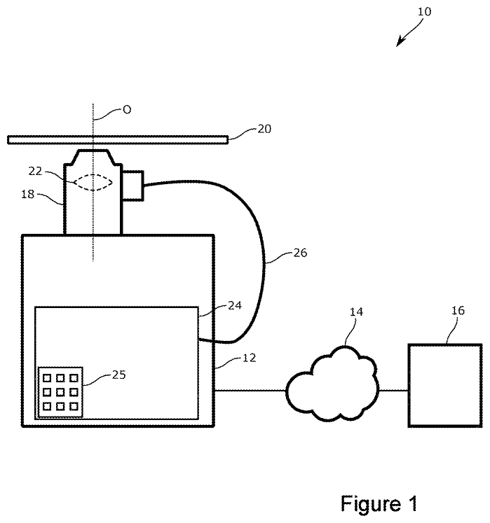

FIG. 1 shows a microscope system 10 as an exemplary embodiment. The microscope system 10 according to an embodiment of the invention comprises a microscope 12, a data remote transmission network 14, and a remote storage module 16. The microscope system 10 furthermore has an objective 18, which faces toward a cover slip 20. In the present exemplary embodiment, the objective 18 represents the optical component activated according to the invention.

The objective 18 contains a correction element 22, which is adjustable to correct an imaging error. In the present case, the correction element 22 is a lens, which is displaceable along the optical axis O of the objective 18. Furthermore, a unique identifier is assigned to the objective 18. This unique identifier is implemented, for example, as human-readable information, for example in the form of a serial number, or as machine-readable information, for example in the form of a barcode, a QR code, or an RFID tag. This information is readable on the objective 18.

The microscope 10 contains a control unit 24, which is connected via a cable 26 to the objective 18 and via the data remote transmission network 14 to the remote storage module 16. The control unit 24 furthermore has an input device 25, by means of which an operator can input data into the microscope system 10.

The remote storage module 16 is, in the exemplary embodiment shown, part of a central server which is connected to the data remote transmission network 14. Alternatively, the remote storage module 16 can also be part of a decentralized storage unit, i.e., a so-called cloud.

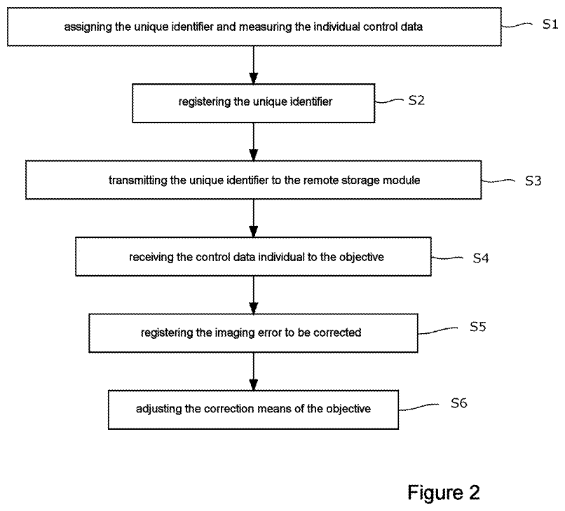

FIG. 2 shows a flow chart which shows an embodiment of the method according to the invention for correcting the imaging error in the microscope system 10 according to FIG. 1.

In a first step S1, in the context of the production of the objective 18, the unique identifier is assigned to the latter. Furthermore, control data individual to the objective 18 are ascertained by means of a suitable method, for example by means of an interferometric measuring method in the final assembly. The control data represent an assignment between the values of an imaging error and the values of a setting variable, using which the correction element 22 is to be activated to correct the imaging error in the later microscope operation. The unique identifier and the control data are linked to one another and stored in the remote storage module 16.

In a second step S2, the control unit 24 receives the unique identifier assigned to the objective 18. This can be carried out, for example, with the aid of a suitable read device. Alternatively, the unique identifier is input into the microscope system 10 by the operator by means of the input device 25.

In a third step S3, the control unit 24 transmits the unique identifier via the data remote transmission network 14 to the remote storage module 16. The transmission can require in particular an authentication step, for example the input of a user identification and/or password, by the operator. Contact data of the remote storage module 16 required for the transmission are input by the user. Alternatively, these contact data are appended to the microscope 12 upon delivery.

In a fourth step S4, the control unit 24 receives the control data individually assigned to the objective 18 from the remote storage module 16 via the data remote transmission network 14.

In a fifth step S5, the control unit 24 registers the imaging error to be corrected in the present microscope operation. The imaging error to be corrected can be registered, for example, in that the imaging error is determined in the microscope operation itself, for example with the aid of a measurement of the cover slip thickness or an index of refraction measurement. Alternatively, the imaging error to be corrected can also be registered in that the operator inputs an item of information corresponding to the imaging error via the input device 25.

In a sixth step S6, the control unit 24 carries out an adjustment of the correction element 22 of the objective 18, in order to correct the imaging error registered in step S5 on the basis of the control data, which have been received in step S4 from the remote storage module 16.

Embodiments of the invention were explained above by means of a special exemplary embodiment. It is obvious that the invention is not restricted to this exemplary embodiment and an array of modifications are possible.

For example, the optical component activated according to an embodiment of the invention does not necessarily have to be an objective. Rather, it can also be any other optical component of the microscope.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 microscope system
12 microscope
14 data remote transmission network
16 storage module
18 optical component
20 correction element
22 cover slip
24 control unit
25 input device
26 cable
O axis
S1 to S5 method steps

1: A method for correcting an imaging error in a microscope system, which comprises a microscope and an optical component, the method comprising:
receiving at least one setting variable from a remote storage module via a data remote transmission network, the at least one setting variable being assigned to the imaging error and individual to the optical component; and
adjusting a correction element contained in the optical component to correct the imaging error using the at least one setting variable.

2: The method as claimed in claim 1, wherein the optical component is an objective.

3: The method as claimed in claim 1, wherein the at least one setting variable is individually measured on the optical component or is calculated from optical data of the optical component, and is then stored in the remote storage module.

4: The method as claimed in claim 1, wherein a unique identifier is assigned to the optical component, by which the at least one setting variable is uniquely assignable to the optical component.

5: The method as claimed in claim 1, wherein an authentication is carried out via the data remote transmission network before the at least one setting variable is received.

6: The method as claimed in claim 1, wherein the imaging error to be corrected is determined at least using the microscope.

7: The method as claimed in claim 6, wherein the imaging error to be corrected and determined at least using the microscope is transmitted from the microscope to the remote storage module, wherein the at least one setting variable is assigned to the transmitted imaging error, and wherein the adjustment of the correction element is carried out based on the at least one setting variable assigned to the transmitted imaging error.

8: The method as claimed in claim 6, wherein an index of refraction of a sample, an embedding medium, an immersion medium, and/or a cover slip and/or a thickness of the cover slip and/or a position of an object plane relative to a position of the cover slip are determined in order to determine the imaging error to be corrected.

9: A microscope system, comprising:
a microscope and an optical component having a correction element, which is adjustable to correct an imaging error using at least one setting variable; and
a remote storage module that stores and is configured to send the at least one setting variable, which is assigned to the imaging error and is individual for the optical component, via a data remote transmission network for the microscope system to adjust the correction element.

10: The microscope system as claimed in claim 9, wherein the microscope comprises a control unit configured to activate the correction element contained in the optical component to correct the imaging error.

11: The microscope system as claimed in claim 9, wherein the microscope system is configured to read out a unique identifier assigned to the optical component, by which the at least one setting variable is uniquely assignable to the optical component.

12: The microscope system as claimed in claim 11, further comprising an input device configured to provide a user-side input of the unique identifier assigned to the optical component.

13: The microscope system as claimed in claim 9, wherein an item of hysteresis information individual to the optical component is stored in the remote storage module, in consideration of which the correction element is adjustable.

14: The microscope system as claimed in claim 9, wherein the correction element comprises at least one lens, which is movable along the optical axis of the optical component for the correction of the imaging error.

15: The microscope system as claimed in claim 9, further comprising a mechanical stop and/or a light barrier for registering a reference value of the setting variable.
